(19) United States
(12) Patent Application Publication
(10) Pub. No.: US 2019/0255524 A1
(43) Pub. Date: Aug. 22, 2019

(54) TRANSFER ARRAYS FOR SIMULTANEOUSLY TRANSFERRING MULTIPLE ALIQUOTS OF FLUID

(71) Applicant: KIMANTECH, L.L.C., Salt Lake City, UT (US)

(72) Inventors: Robert Parry, Salt Lake City, UT (US); Nils Adey, Salt Lake City, UT (US)

(21) Appl. No.: 16/312,922

(22) PCT Filed: Jul. 12, 2017
(86) PCT No.: PCT/US2017/041741

§ 371 Date: Dec. 21, 2018

Related U.S. Application Data
(60) Provisional application No. 62/365,513, filed on Jul. 22, 2016.

(51) Int. Cl. B01L 3/00; G01N 35/10; B01L 3/02

(52) U.S. Cl. CPC B01L 3/5025; B01L 3/56; B01L 3/527; B01L 3/021; G01N 35/1065

(57) ABSTRACT

A method for transferring multiple aliquots of fluid, the method including: contacting the multi well plate or strip with a transfer array and simultaneously aspirating fluid from multiple wells of the multi well plate or strip into corresponding hollows in the transfer array.

### BACKGROUND

Biochemistry and genetic chemistry make extensive use of multi well plates and multi well strips. A multi well plate is a flat device with a number of recessed wells. A multi well strip is similar except the wells are arranged in a linear fashion. Generally, the wells on a given plate or strip are uniform in size and arranged in an orderly pattern to facilitate automated or semi-automated processes. Common configurations of well plates include: 6, 12, 24, 48, and 96 well formats. Common configurations of well strips include 8 and 12 well formats. Large well plates may include hundreds of wells to facilitate automated and/or high volume testing.

Each well in a well plate may serve as a separate test volume. This allows larger numbers of samples in a small area and may reduce sample preparation time. The compact size, portability, and ability to keep the test samples organized make well plates useful tools in evaluating chemical and biological reactions.

One challenge with well plates is loading or unloading test components. Loading and/or unloading volumes of fluid into a large number wells on a plate can be a tedious and time consuming operation. Further, the use of a single tip, for example, on a micropipette or a transfer pipette, may allow cross contamination between wells. Accordingly, it is desirable to enhance the ability to load and unload multi well plates.

### BRIEF DESCRIPTION OF THE DRAWINGS

The accompanying drawings illustrate various examples of the principles described herein and are a part of the specification. The illustrated examples are given merely for illustration, and do not limit the scope of the claims.

FIG. 1 is a cross-sectional diagram of an array element, according to one example of the principles described herein.

FIG. 2 is a top view of an array according to one example of the principles described herein.

FIG. 3 is a cross-sectional diagram of an array element, according to one example of the principles described herein.

FIG. 4 is a cross-sectional view of two arrays interacting, according to one example of the principles described herein.

FIG. 5 is a cross-sectional diagram of an array element, according to one example of the principles described herein.

FIG. 6 is a cross-sectional view of an array and a multi well plate according to one example of the principles described herein.

FIG. 7 is a cross-sectional diagram of an array element, according to one example of the principles described herein.

FIG. 8 is a cross-sectional diagram of an array element and a well of a multi well plate, according to one example of the principles described herein.

FIG. 9 is a cross-sectional diagram of an array element, according to one example of the principles described herein.

FIG. 10 is a cross-sectional diagram of an array element, according to one example of the principles described herein.

FIG. 11 is a flowchart of a method according to one example of the principles described herein.

FIG. 12 is a cross-sectional diagram of a transfer array holding fluid and a storage tray according to one example of the principles described herein.

FIG. 13 is a cross-section diagram of an array element showing a method of filling and mixing solutions using a transfer array according to one example of the principles described herein.

FIG. 14 is a cross-sectional diagram of a transfer array in a conformal well plate according to one example of the principles described herein.

Throughout the drawings, identical reference numbers designate similar, but not necessarily identical, elements.

### DETAILED DESCRIPTION

Transferring fluids into, from, and between well plates is a common and time consuming task in genetic, chemical, and biological sciences. These areas have seen increasing discovery and automation as new test methods are developed and transferred to commercial or clinical use. Transfer pipettes are one method of transferring fluids. Similarly, micropipettes with disposable tips may be used to transfer fluid. These either use a large number of consumables and/or risk cross contamination between wells.

This specification describes, among other examples, a transfer array for transferring fluids to, from, and/or between well plates and strips. While the described transfer arrays may be patterned for standard well plates, the designs can also be patterned to customized or unusual designs with minimal difficulty.

In one example, the transfer array is formed from two sheets of material. The two sheets include a number of transfer elements arranged to align with wells in a well plate. The transfer elements are formed from shaped areas of the upper and lower sheet and contain a hollow area between the sheets. The upper sheet portion of the transfer element functions as a bulb which may be compressed to expel fluid and recoils to generate a vacuum to aspirate fluid. In this manner, the transfer element is similar to a transfer pipette. The lower sheet portion of the transfer element includes a tip with an opening. Fluid moves in and out of the transfer element through a hole in the tip.

The phrase well plate as used in the specification and the associated claims should be understood broadly to cover a structure including a plurality of recessed wells. A well plate may be a linear array of wells, such as a well strip. A well plate may contain a two dimensional array of wells as in a traditional well plate. A well plate may include multiple wells in staggered or other irregular patterns.

As used in the present specification and in the appended claims, the term “a number of” or similar language is meant to be understood broadly as any positive number comprising 1 to infinity.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an example” or similar language is understood that a particular feature, structure, or characteristic described in connection with that example is included as described, but may not be included in other examples.

The present specification, therefore describes a transfer array for simultaneously transferring multiple aliquots of fluid including: a formed upper sheet and a formed lower sheet contacting the upper sheet, the upper sheet and lower sheet forming a plurality of hollows between the upper formed sheet and the lower formed sheet, wherein the plurality of hollow are spaced to align with wells in a well plate or strips in a well strip; each hollow of the plurality of hollows comprises a hole in the lower formed sheet to allow aspiration of fluid into the hollow and expulsion of fluid from the hollow; and the portion in the upper sheet forming each hollow extending away from the lower sheet and the portion of the lower sheet forming each hollow extending away from the upper sheet.

The present specification also describes a device for providing preloaded aliquots of liquid, the device including: a plurality of transfer pipettes formed from two sheets of material, each transfer pipette of the plurality of transfer pipettes holding an aliquot of liquid and a tray conforming to lower tips of the transfer pipettes, the tray limiting evaporation of the liquid in the transfer pipettes.

The present specification also describes a method for transferring liquid from a first multi well plate or strip, the method comprising: contacting the first multi well plate or strip with a first transfer array and simultaneously aspirating fluid from multiple wells of the first multi well plate or strip into corresponding hollows in the first transfer array;

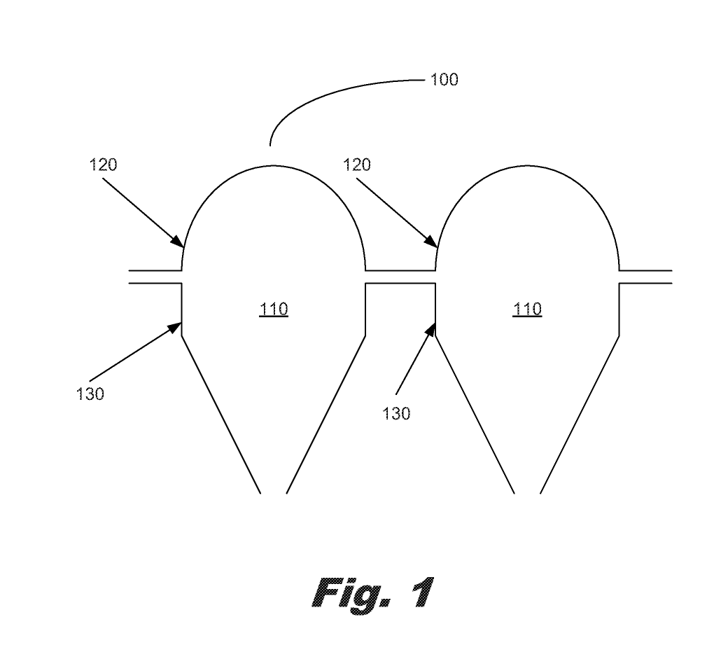

Turning now to the figures, FIG. 1 is a cross-sectional diagram of two transfer elements (110), according to one example of the principles described herein. The transfer array (100) is made of an upper sheet (120) and a lower sheet (130). The upper sheet (120) and lower sheet (130) are attached to as to seal around the transfer element (110).

The transfer array comprises a plurality of hollows formed between an upper sheet (120) and a lower sheet (130). The hollows serve as transfer elements (110) that aspirate and expel fluid. The transfer elements (110) can be activated individually, in groups, or all at once. For example, an entire transfer array (100) may be loaded in a single operation. The transfer array (100) can then be moved to a new multi well plate and the solution from the transfer array discharged by rows into the multi well plate at preselected time intervals.

The transfer element (110) is formed between the upper sheet (120) and the lower sheet (130). The transfer elements (110) may be formed in a traditional array with rows and columns. The transfer elements (110) may be formed in other patters or arrangements. The transfer elements (110) in a given array (100) may be of uniform size and shape. The transfer elements (110) in a given array (100) may include a variety of shapes and sizes. For example, each row of the transfer array may be designed to take up a different volume of fluid at a given depression of the upper sheet. These different volumes can then be applied to a well plate to provide a range of tests. A second transfer array where the rows each contain a different quantity of a second fluid can then be injected into the same wells to create a response array.

The upper sheet (120) may be formed from a variety of materials. In some examples, the upper sheet is a thermoplastic, for example, polyethylene (PE, HDPE, LDPE). The upper sheet may be a thermoset polymer, for example silicone rubber. The upper sheet (120) may be a composite, for example, a rubberized framework. In one example, the upper sheet comprises a silicone rubber with a durometer of 20A to 70A.

In one example, the upper sheet (120) is molded. The advantages of molding parts include relatively low process variation and low cost of the formed parts. In one example, the molding is injection molding. In one example, the molding is liquid injection molding (LIM).

In one example, the upper sheet (120) is thermoformed. Thermoforming may use less expensive capital equipment than molding. Thermoforming molds may be cheaper to make and/or modify than injection molding molds.

In one example, the upper sheet (120) is cast. For example, the upper sheet may be case into a mold formed around a 3D printed or machined part. Casting allows rapid prototyping in the development of parts, especially parts that will be formed from thermosets.

The upper sheet (120) may include a standardized interface with the lower sheet (130). For example, all upper sheets (120) may be designed to attach to all lower sheets (130). In another example, the interfaces can be designed to allow certain combinations or a single combination of upper sheets (120) and lower sheets (130) to avoid errors.

In one example, the upper sheet (120) includes a molded in reference number that aligns with a feature on the lower sheet (130). For example, the upper sheet may have a range of bottoms and each bottom may have a feature, which is associated with the actual bottom such that when the top sheet and bottom sheet are assembled, the feature indicates the combination of top sheet and bottom sheet for a user. These elements may be mechanical features or printed on one or both sheets (120, 130)

The lower sheet (130) may be formed of the same material or a different material as the upper sheet (120). The lower sheet may (130) be a more rigid material or a more rigid design. In one example, the lower sheet includes ridges, spars, sprues, or similar features to provide additional stiffness to the lower sheet (130).

In one example, the lower sheet (130) is relatively rigid compared with the upper sheet (120). For example, the lower sheet (130) may be formed of polyurethane (PU), polyether ether ketone (PEEK), polystyrene (PS), polycarbonate (PC), polyethylene teraphalate (PET), polyimide (PI), and similar materials. The lower sheet may be injection molded. The lower sheet (130) may be thermoformed. The lower sheet may be a thermoplastic such as polyethylene. The lower sheet (130) may be cast, for example from epoxy or silicone rubber. Because of the relatively flat form of the lower sheet (130), forming the lower sheet (130) may avoid the need for a large number of pins or similar elements to form holes in the lower sheet (130). The lower sheet (130) may be formed of non-polymers including metal, ceramic, glass, composites, etc.

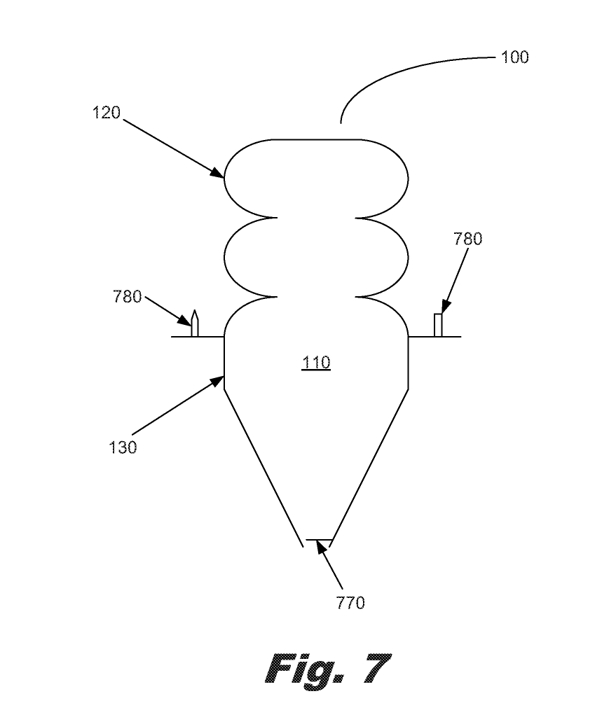

In one example, the holes are formed during forming of the lower sheet (130). In a second example, the holes are formed in a secondary operation, for example, a punch. The holes in the lower sheet (130) may be of uniform size and shape. The holes in the lower sheet (130) may be of different sizes and/or shapes. The holes in the lower sheet (130) may include a valve (See below, FIG. 7). In one example, the valve is formed using an incomplete punch, e.g. a crescent or semicircular punch.

The lower sheet (130) may include features that facilitate alignment with the wells of a multi well plate. These same features may facilitate alignment with the upper sheet of a second transfer array. The portion of the lower sheet (130) that forms the walls of the transfer elements may press against the walls of the wells of the well plate. In one example, this facilitates the sealing of the well plate. In another example, an airway is provided between the lower sheet (130) and the side of the well of the well plate to allow airflow in and out of the well. The airway may be sized to allow airflow while reducing evaporation by restricting diffusion.

The lower sheet (130) and the upper sheet (120) may be connected in a variety of manners. In one example, the upper sheet (120) and lower sheet (130) include a one way connection such that the upper sheet (120) snaps into position on the lower sheet (130) or vice versa. The snap connection may provide a compressive force to seal the perimeter of the transfer elements between the upper sheet (120) and the lower sheet (130).

In one example, the upper sheet and lower sheet are thermally welded together. This may be accomplished using a variety of processes, for example, resistive welding. In an example, the upper sheet and lower sheet are connected with adhesive and/or solvent bonding. The surfaces of the upper sheet (120) and lower sheet (130) that contact each other may be modified to increase bond strength or bonding reliability. This may include texturing the mold or providing ridges, groves, primer, weld features, etc. to strengthen connection between the upper sheet (120) and the lower sheet (130).

The portion of the lower sheet (130) that forms the bottom of the transfer element (110) may include a piercing tip and/or a separating or parting edge/rib/ridge to allow one transfer array to interlock with a second transfer array and receive and/or transfer fluid through the first array.

The piercing tip may be symmetrical. The piercing tip may be asymmetrical. The piercing tip may be a formed or sharpened using a secondary operation to reduce the force to penetrate an upper sheet (130). The lower sheet (130) may include parting ribs or other elements to facilitate opening the upper sheet (120). In one example, the upper sheet is a highly crystalline thin polymer film such as BOPET. This may provide adequate mechanical strength and flexibility while still allowing easy penetration by a penetrating tip and propagation of the opening by a parting rib.

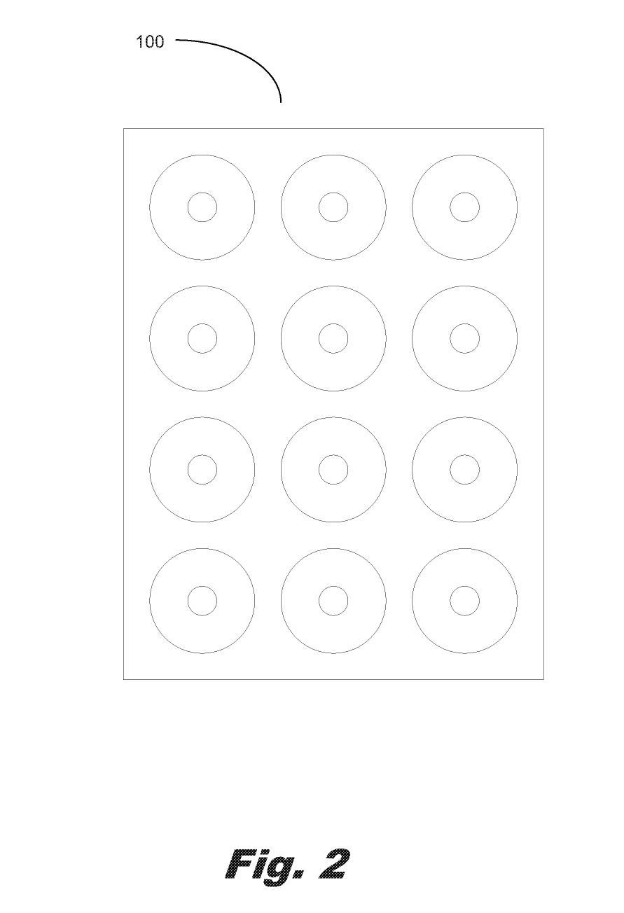

FIG. 2 is a top view of a transfer array (100), according to one example of the principles described herein. The transfer array (100) includes a number of transfer elements (110). The transfer elements (110) may be organized in standardized rows and columns. The transfer elements (110) may be arranged to correspond with the locations of wells in a well plate. The transfer elements may form a variety of patterns. For example, the transfer array may include transfer elements over some rows and not over other rows. The transfer array (100) may have transfer elements for every other well or every third well of the well plate. The ability to select patters of transfer elements and patterns of volumes of transferred fluid in different elements allows the rapid loading of a well plate with a pattern of test volumes.

The transfer array may be loaded from a well plate. The transfer array (100) may be loaded from a common reservoir. In one example, the common reservoir includes weep holes or an overflow weir to allow rapid filling of the transfer array from a fixed immersion depth without having to individually pipette fluid into wells of a transfer plate. In one example, the plate can be tilted to cause fluid to flow from an overflow reservoir back into the transfer area in order to load a second transfer array.

In one example, the transfer array (100) includes stops on the upper sheet (120) and/or the lower sheet (130). The stops limit travel of a plate compressing the upper sheet during loading and unloading. The stops may facilitate reproducible filling or discharge of the transfer array. In one example, the pressor plate includes a hole or window to avoid a first set of stops and travel to a second set of stops. For example, depending on the plate use, the transfer elements (110) may be loaded with 500 microliters or 1 milliliter of solution.

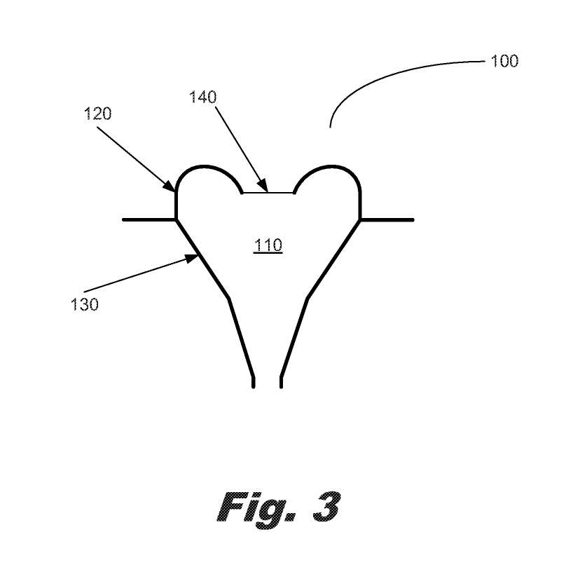

FIG. 3 is a cross-sectional diagram of an array element, according to one example of the principles described herein. FIG. 3 shows an array element (110) with formed of an upper sheet (120) and a lower sheet (130). The array element (110) also includes an access point (140).

The access point (140) facilitates the use of multiple transfer arrays (100). The access point (140) is an area in the upper sheet that is part of the transfer element that is designed to facilitate injection or aspiration of material into a second transfer array (100) through a first transfer array (100). In one example, the access point is an area of reduced but non-zero local thickness in the upper sheet. The access point (140) may be an area of different mechanical properties that facilitate penetration of the upper sheet (130). For example, if the upper sheet is composed of silicone rubber, the access point may be degraded with UV radiation or similar so as to be relatively stiff and non-pliable. The access point (140) may be an insert molded into the upper sheet (130).

The access point (140) may be sealed by a second film or foil that is over molded by the upper sheet (120). In one example, the access point (140) is covered by a metal foil. In one example, the access point (140) is covered by a biaxially oriented ethylene terephthalate (BOPET) film.

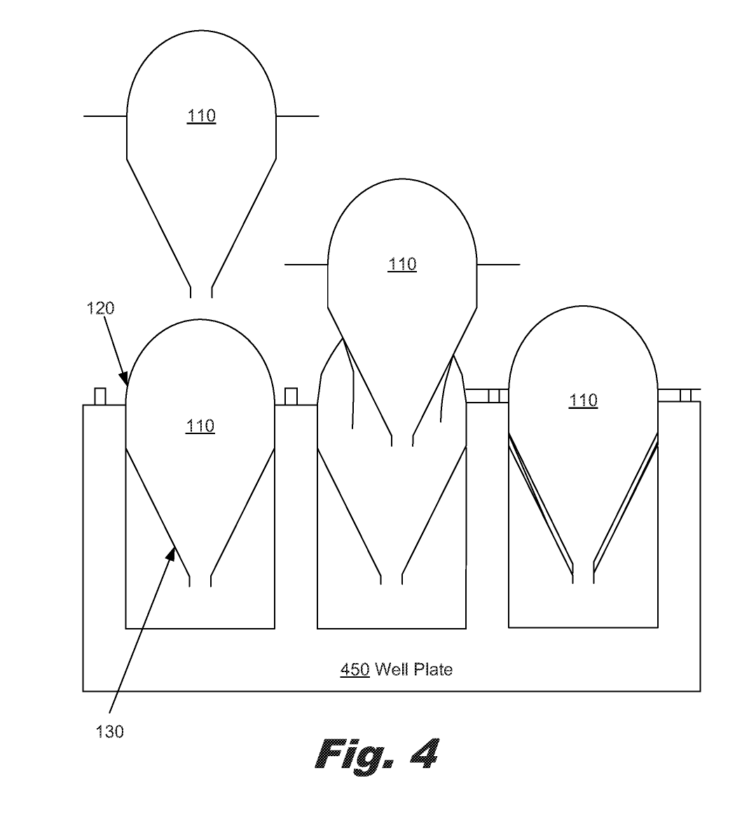

FIG. 4 is a cross-sectional view of two transfer arrays interacting, according to one example of the principles described herein. The first transfer array (100) sits on a well plate (450). The second transfer array (400) has been previously loaded with fluid. The second transfer array descends and penetrates the first transfer array. The fluid in the second transfer array may then be expelled into the wells of the well plate (450). In this manner fluids can be added sequentially to the reaction wells without having to unseal it, thereby avoiding exposing the surrounding environment to the contents of the well. Fluid in the well plate (450) may also be aspirated into the second transfer array (400).

In one example, the tip of the transfer element (110) is designed to interface with the inside of the tip of a second transfer element (110). This may help isolate any residual volume between the first and second transfer arrays. In this example, the outer diameter of the external portion and the inner diameter of the tip of the transfer element are selected to interlock. The outer circumference of the tip may be tapered toward the lower end of the tip in order to help align the two transfer arrays. In one example, the external length of the tip is correlated with a height of stops to support the lower sheet (130) of the second transfer array (400). The stops may serve the dual function of limiting the travel of the second transfer array and stabilizing the second transfer array on the first transfer array.

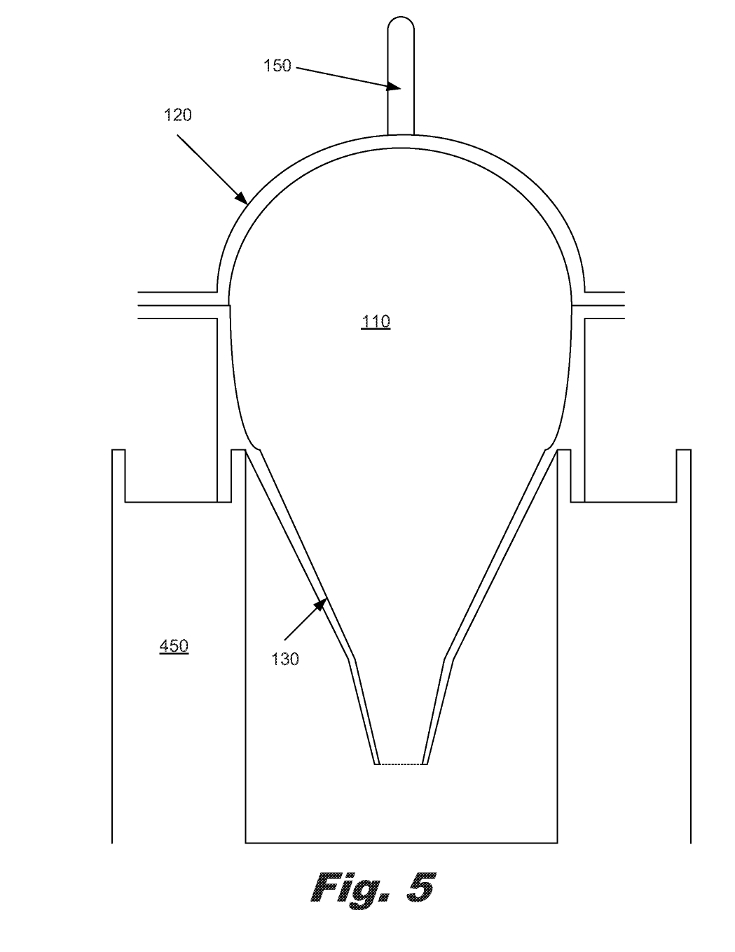

FIG. 5 is a cross-sectional diagram of an array element, according to one example of the principles described herein. FIG. 5 shows a variety of shapes for the upper sheet (120) portions of transfer elements. These shapes can be mixed and matched on a single upper sheet (120). In another example, the upper sheet may include a single shape configuration.

The upper sheet (120) may be designed to have a non-linear relationship between volume change and compression. In one example, the upper sheet (120) may be designed to minimize volume change with respect to compression at various levels of compression corresponding to expected transfer volumes. For example, the upper portion may include a plurality of accordion like elements of different thicknesses that allow for the targeting multiple specific transfer volumes.

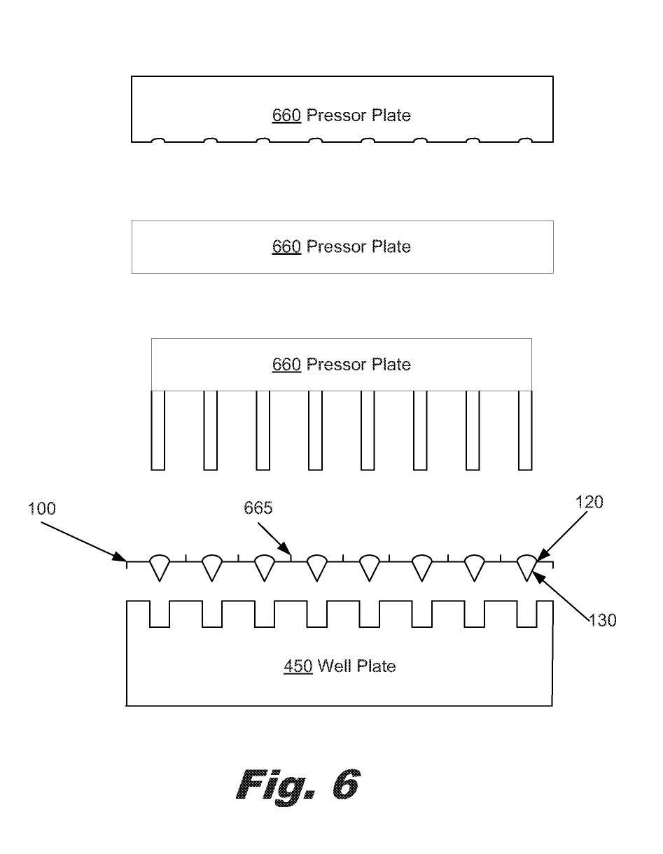

FIG. 6 is a cross-sectional view of an array and a multi well plate according to one example of the principles described herein. In this view the upper sheet (120) and lower sheet (130) of the transfer array (100) are visible. The transfer array (100) is on a well plate (450). A presser plate (660) with a plurality of pins is shown pressing the upper sheet (120) in order to actuate the transfer elements (110) and expel the fluid from the transfer array (100) into the well plate (450). The transfer array (100) may include a number of stops (665).

The pressor plate (660) may include a number of pins as shown. The pins may be of uniform height. The pins may be of different heights to produce different amounts of fluid transfer. The use of a pressor plate (660) with pins offers flexibility in terms of process

As shown in FIG. 6, the pressor plate (660) may be flat. The use of a flat pressor plate (660) offers some advantages in alignment. For example, with pin based plates, small changes in the pin position on the upper sheet (120) over the transfer element (110) may change the volume vs. height relationship. The use of a flat plate avoids this issue. A flat pressor plate (660) is also less susceptible to incidental damage that pins, especially the pins near the periphery of the array. Finally, pins will have some inherent variation in their diameter which, depending on the shape of the upper sheet (120) portion of the transfer element may increase the variation in the array.

The pressor plate (660) may include a plurality of rounded indents as shown in FIG. 6. The rounded indents may provide a different compression profile than that of a flat plate. The rounded indents may provide a larger contact area between the pressor plate (660) and the upper sheet (130). In some examples, the rounded indents may provide greater control over fluid delivery. The rounded indents may be less susceptible to alignment errors than the pins. The rounded indents may be more susceptible to alignment errors than the plate pressor plate (660). Accordingly, there are design tradeoffs that should be considered when implementing these features depending on the priorities of the user.

The pressor plate (660) may interact with a recovery feature on the upper sheet (120) and/or lower sheet (130). The recovery feature may be a stern (150) The recovery feature may be eyelets, pins, hooks, or similar structures that allow interaction with the pressor plate (660). In one example, each transfer element (110) has a recovery feature located on the upper sheet (120) of the transfer element (110). The recovery feature facilitates aspiration of fluid in the transfer element (110). The recovery feature allows the use of a wide range of materials for the upper sheet (120) that would otherwise not have adequate elastic recoil. In one example, the pressor plate is able to gasp or otherwise pull on the recovery feature. In one example, the pressor plate includes a plurality of holes. The holes may be tapered to facilitate alignment. The holes may receive a stem (150) extending upward from each transfer element. The stems (150) may be held relative to the pressor plate (660). In one example, the pressor plate (660) includes a second plate that slides laterally to the pressor plate (660). The second plate includes a set of aligned holes that receive the stems (150). When the second plate slides, the relative motion of the pressor plate (660) and the second plate locks the stems (150) in place.

The pressor plate (660) may include hooks to interact with eyelets or hooks associated with the transfer element (110). In one example, the hooks on the pressor plate (660) are barbed pins. The barbed pins deflect a portion of the upper sheet (130) during compression. On retraction, the barb on the pin exerts upward force on the upper sheet (130) to facilitate aspiration of fluid.

The pressor plate (660) may include stops over portions of the upper sheet. The stops may be similar to long pins that eventually touch the upper sheet (120) during dispensing and/or aspirating and help control the travel of the pressor plate (660). Stops may be useful for ensuring uniform compression over the entire transfer array. In one example, stops are used with a plate on a ball and socket joint. This allows the stops to provide the functionality of leveling the pressor plate (660). In another example, the stops can be aligned to create a desired final slope for the pressor plate in order to provide a gradient of pressure across a transfer array.

The upper sheet (120) and/or lower sheet (130) may include stops (665). The stops (665) may be features of the well plate (450). The stops (665) may serve as both stops (665) and alignment features or guides for the upper sheet (120) and/or lower sheet (130). The stops (665) may be formed of the same material as the upper sheet (120). The stops (665) may be formed of the same material as the lower sheet (130). The stops (665) may be formed of the same material as the well plate (450). The stops (665) may be formed of a different material, for example, a metal or structural polymer (e.g. polycarbonate). The stops (665) may limit travel of the pressor plate (660). The stops (650) may stabilize the position of the upper sheet (120), lower sheet (130), and well plate (450) relative to each other. The stops (665) may include reversible locking features or one way clasping features.

FIG. 7 is a cross-sectional diagram of a transfer element (110), according to one example of the principles described herein. The transfer element (110) includes an upper sheet (120) and lower sheet (130). The hole in the lower sheet (130) that allows fluid in and out of the transfer element (110) includes a valve (770). FIG. 7 also shows an example of an alignment pin (780).

The inclusion of the valve (770) in the tip of the transfer element (110) may facilitate larger transfer volumes in the transfer elements (110). The valve (770) may reduce evaporation of fluid in the transfer element during storage, for example, by reducing the surface area exposed to the outside environment. While the valve (770) is shown as a flap valve, other designs are possible.

In one example, the valve (770) is formed during molding the lower sheet (130). The valve (770) may be formed by a secondary operation, for example a partial punch with a crescent or circular punch may be used to form the valve.

The alignment pin (780) may protrude through a hole in the upper sheet (120). The alignment pin (780) may be an integrated part of the lower sheet (130). In one example, the alignment pin is integrated into the well plate (450) and both the upper sheet and lower sheet (130) include holes or other features to take advantage of the alignment pin (480).

The alignment pin (780) may have a conical or rounded top to help guide upper sheet (120) and/or lower sheet (130) into position. In one example the alignment pin includes ratchet or similar clasping device to secure the upper sheet (120) and lower sheet (130) relative to each other. This may be as simple as an enlarged section above a reduced section. Such devices may include tapers to facilitate attachment. The position of the alignment pins (780) may be used to limit which upper sheets (120) can be attached to a given lower sheet (130). The position of the alignment pin may provide information about the type of bottom sheet used. For example, there may be a plurality of holes in the upper sheet that can accommodate a variety of patterns of alignment pins. The holes may have symbols or text near them to indicate the type of lower sheet associated with pins in that location. The alignment pins may also perform some of the functions of the stops (660).

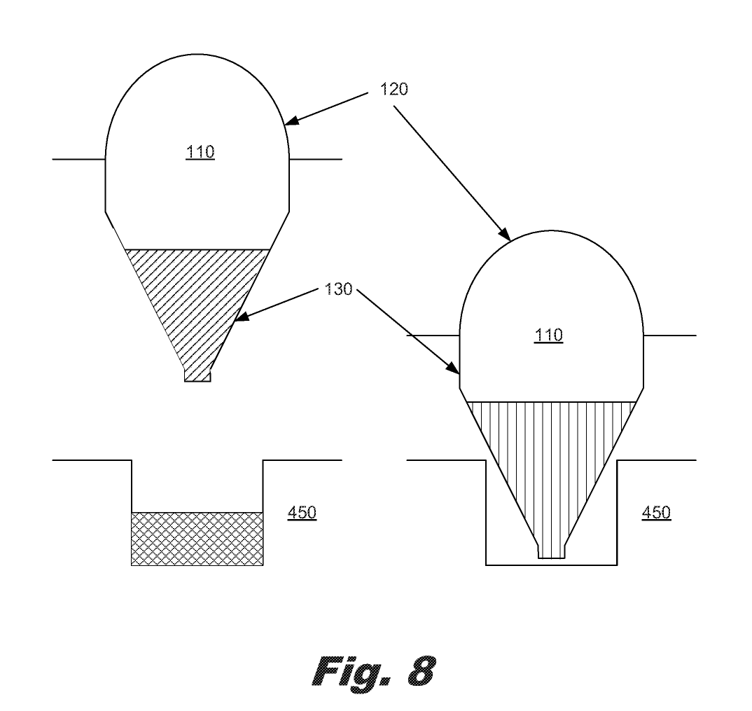

FIG. 8 is a cross-sectional diagram of a transfer element (110) and a well of a multi well plate (450), according to one example of the principles described herein. The transfer element (110) is formed of an upper sheet (120) and a lower sheet (130). In FIG. 8, the portion on the left shows the before condition. The well holds an amount of fluid. A transfer element (110) with a second fluid is brought into contact with the fluid in the well. The fluid in the well and fluid in the transfer element are mixed by aspiration. In one example the fluid in the well and fluid in the transfer element are mixed using multiple aspiration/expulsion cycles. As seem on the right, the mixed fluid is then aspirated into the transfer element (110), either to react and/or be transferred to a different location for further processing.

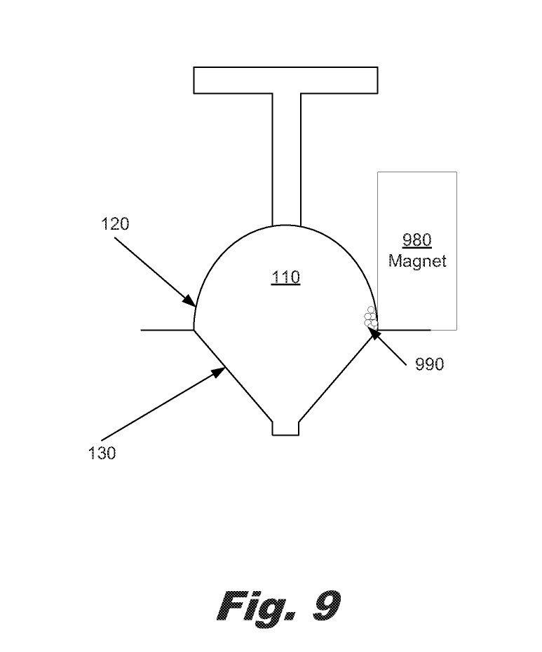

FIG. 9 is a cross-sectional diagram of an array element (110) and a well of a multi well plate (450), according to one example of the principles described herein. FIG. 9 shows a method for removing magnetic beads (990) from a sample without exposing the sample to a potential contaminant source.

In this example, a solution containing magnetic beads (990) is aspirated into the transfer element (110). The solution may be aspirated and expelled multiple times. The magnetic beads (990) are attracted to a magnet (980) or magnetizable component proximal to the volume of the transfer element (110). This causes the magnetic beads (90) to adhere to the side of the transfer element (110). Once more or all of the magnetic beads have been captured, the solution in the transfer element (110) can be expelled and the solution further processed or tested without the interference of the magnetic beads. Alternatively, the sample of interest may be captured by the magnetic beads, the fluid expelled from the transfer element (110), and a new fluid aspirated into the transfer element (110).

In one example, the magnets (980) are located on a comb-like structure that is inserted laterally across the transfer array. The tines of the comb-like structure have magnets (980) located so as to proximal to the desired transfer elements (110). In one example, the tines with the magnets (980) or magnetizable material (e.g. iron) is curved to contour around the outside of the transfer elements (110) of the transfer array (100).

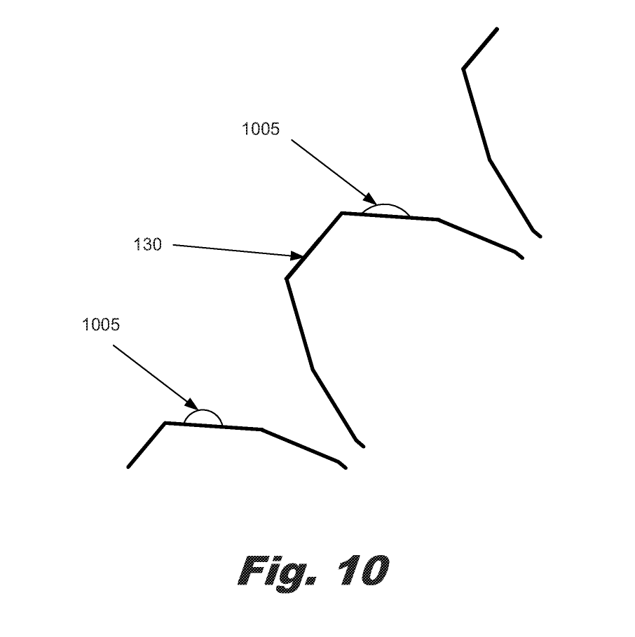

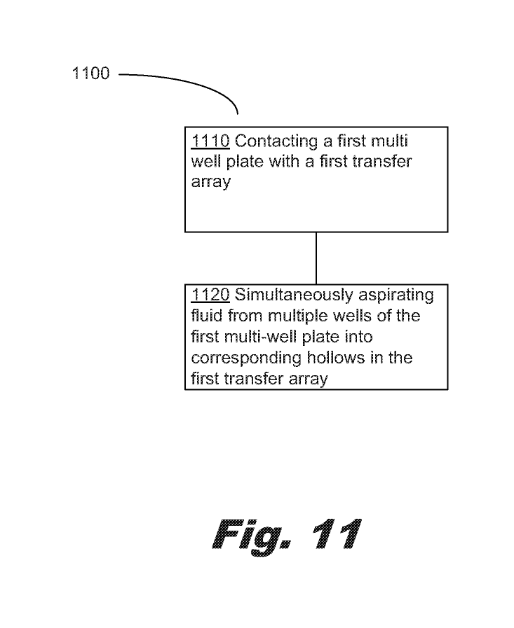

FIG. 10 is a cross-sectional diagram of an array element, according to one example of the principles described herein. FIG. 10 shows a chemical (1005) located on the inside of the transfer element (110) part of the lower sheet (130). The reagent could also be located on the upper sheet (120).

In one example, the lower sheet (130) has a solid chemical (1005) applied to the inner surface. The solid chemical (1005) can be applied as a droplet and allowed to dry. The solid chemical (1005) may be applied as a film, a paste, a slurry, a vesicle, a micelle, etc. In one example, the chemical (1005) is applied to the lower sheet (130) prior to putting the upper sheet (120) and lower sheet (130) together. The lower sheet (130) may include a contoured portion to facilitate placement of droplets while drying. For example, the edges of the lower sheet (130) may include angled flaps to help stabilize the lower sheet at an angle. The inner surface of the lower sheet (130) may include flat areas or divots that facilitate holding droplets of fluid while the lower sheet (130) is at an angle. In another example, the chemical (1005) may be applied as a spray or other technique which allows the chemical (1005) to solidify on the interior surface of the transfer element (110). The chemical can be any component that might be added to a well plate. Preferably, the chemical (1005) is stable and does not degrade between application and use. In some examples, the transfer array is shipped with the chemical preloaded to facilitate rapid work. In some examples, the material of the lower sheet (130) may be selected to contain the chemical (1005) without reacting with the chemical. While the chemical (1105) may be solid, the chemical (1105) may also be a viscous fluid, a slurry, a thixotropic fluid, a suspension, an emulsion, etc. as long as the chemical (1005) can remain stable on the inner wall of the transfer element (110) between the time of application and the time of use.

In one example, the transfer element (110) aspirates a fluid that dissolves the chemical (1005) to form a solution. In some examples, the transfer element (110) may aspirate and expel the fluid multiple times to enhance dissolution by enhancing the local mixing and sheer. The speed and profile of aspiration and expulsion of the fluid may be optimized based on the solution, temperature, solid material, etc. In one example, the chemical (1005) includes a mixture of high solubility and low solubility materials, the high solubility material being used to stabilize the low solubility material as a fine particulate in order to enhance the rate of dissolution. In another example, the chemical (1005) is a liquid contained in a soluble film.

FIG. 11 is a flowchart of a method (1100) for transferring liquid from a first multi well plate according to one example of the principles described herein. The method comprises: contacting (1110) the first multi well plate with a first transfer array and simultaneously aspirating (1120) fluid from multiple wells of the first multi well plate into corresponding hollows in the first transfer array.

Contacting (1110) the first multi well plate with a first transfer array may include the use of alignment features on the multi well plate and/or the transfer array.

Simultaneously aspirating (1120) fluid from multiple wells of the first multi well plate into corresponding hollows in the first transfer array may include moving a pressor plate to allow recoil of the upper sheet (120). In some examples, the pressor plate mechanically connects with the upper sheet (120). For example, the upper sheet (120) may include bars, ribs, hooks, eyelets, or similar features that mechanically couple the pressor plate and the upper sheet (120). These features may allow the pressor plate to also pull the upper sheet (120) away from the lower sheet (130) to better control aspiration of fluid into the hollows and/or transfer elements (110).

The method may also include other elements, for example, contacting a second multi well plate with the first transfer array; simultaneously expelling fluid from multiple hollows of the first transfer array into corresponding wells of the second multi well plate; attaching the transfer array (100) to the second multi well plate (450) in order to seal it and/or storing the transfer array (100) on a tray, where the transfer array (100) contains aspirated fluid; penetrating hollows of a second transfer array (100) with lower tips of the first transfer array (100); and/or simultaneously expelling fluid from multiple hollows of the first transfer array (100) into hollows of the second transfer array (100). The method may further comprise mechanically connecting the first transfer array (100) to the second transfer array (100).

In one example, the aspirated fluid is a solvent which dissolves a chemical and the expelled fluid is a solution. Contacting the first multi well plate (450) with a first transfer array (100) may seal wells of the first multi well plate (450).

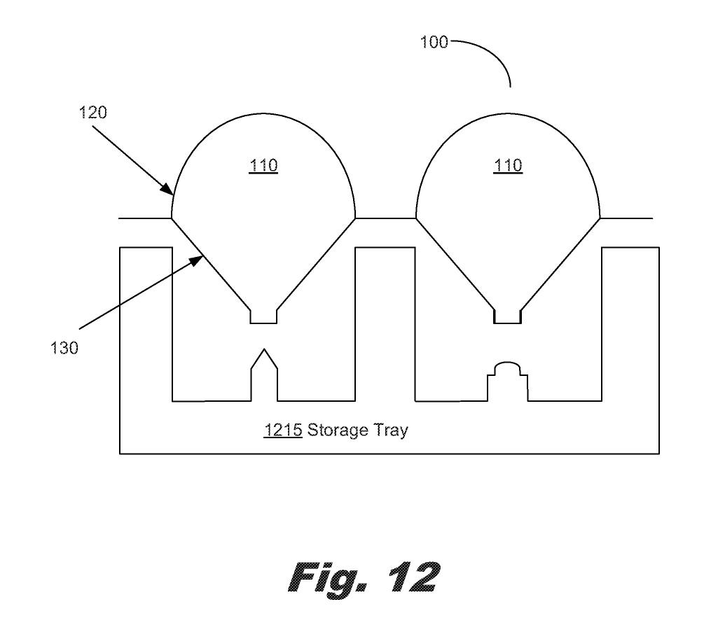

FIG. 12 is a cross-sectional diagram of a transfer array holding fluid and a storage tray accordingly to one example of the principles described herein. The transfer array (100) is shown on a storage tray (1215). The storage tray helps reduce spills and leakage during the storage of fluids in the transfer array (100). The storage tray includes wells similar to a well plate (450). In some examples, the storage tray also includes a pin to seal or block the tip of the transfer elements (110) to further reduce evaporation and provide stability during transportation or shipping.

The pin may be tapered or conical. The pin may include a shoulder or similar support to stabilize the transfer array (100). The pin may be molded as part of a well plate. The pins may be on a lattice without wells.

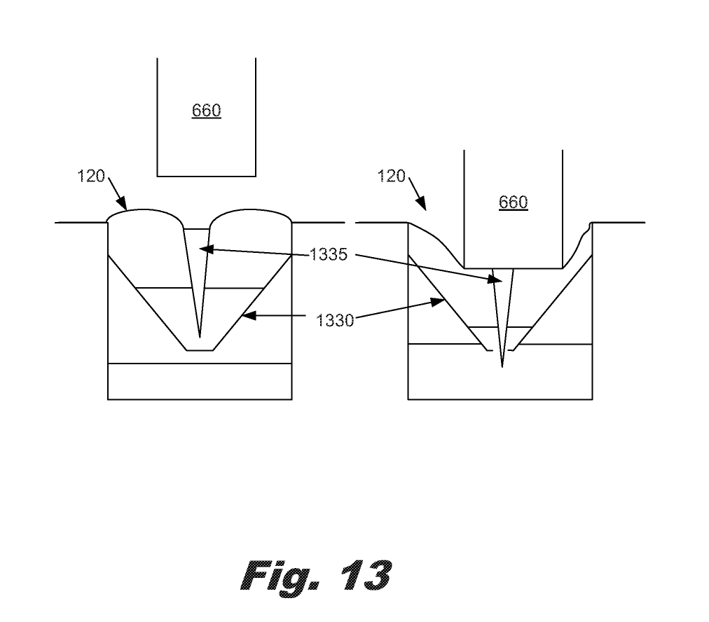

FIG. 13 is a cross-section diagram of an array element showing a method of filling and mixing solutions using a transfer array according to one example of the principles described herein. The continuous lower sheet (1330) is formed similar to the lower sheet but does not have a hole in the bottom the transfer element (110). The upper sheet (120) includes a punch (1335) that when depressed by a pusher plate (660), for example a pin opens a hole in the continuous lower sheet (1330).

In this example, the continuous lower sheet (1330) may be loaded with a fluid. The upper sheet (120) with the punch is then applied over the continuous lower sheet (1330). This forms a variety of sealed transfer elements (110). The lack of an opening in the transfer element (110) reduces evaporation and the risk of contamination. The transfer array is then placed over a well plate (450) that may contain a second liquid in the wells of the well plate (450). The upper sheet (120) is pressed down and the punch (1335) creates a hole in the continuous lower sheet (1330). In one example, the continuous lower sheet (1330) includes an access point (140) similar to those described above for the upper sheet (120). With a hole in the continuous lower sheet (1530), the two fluids mix. The fluids can be agitated using the pressor plate (660). The mixed fluids can be aspirated back into the transfer element (110) and transferred to another well plate (450).

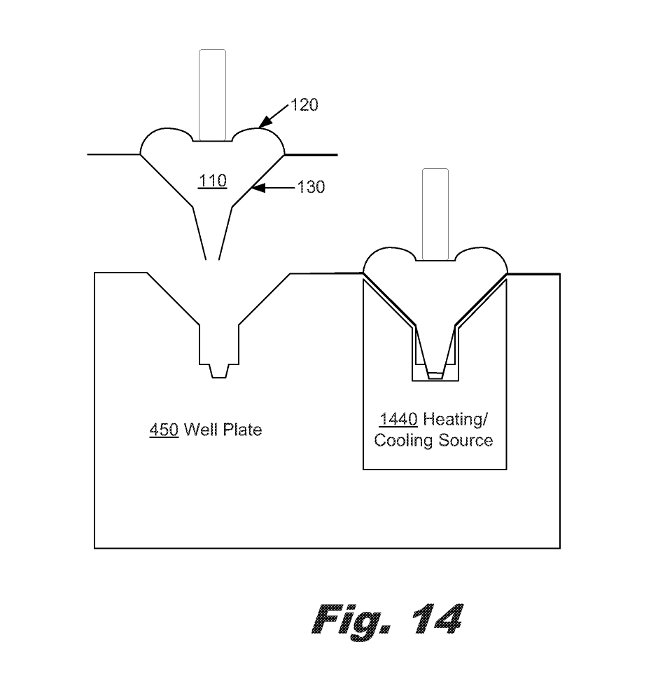

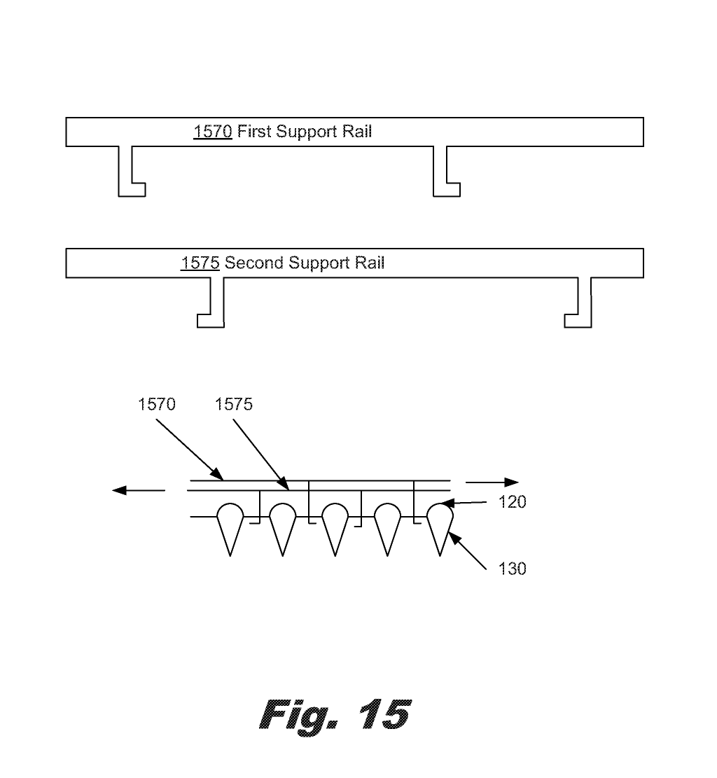

FIG. 14 is a cross-sectional diagram of a transfer element (110) in a conformal well plate (450) according to one example of the principles described herein. In this example, the well plate (450) is shaped to conform to the lower sheet (130) of the transfer array such that at least a portion of the lower sheet (130) contacts the walls of the well. In one example, more than half the lower sheet (130) in the well is in contact with a well wall.

In one example, a heating and/or cooling source (1440) is available below the well plate (450). The wall of the transfer element (110) is in contact with the well wall, heat transfer between the heating or cooling element and the transfer volume in enhanced. In contrast, an air gap between the lower sheet (130) and the well wall serves as an insulator. In one example, at least half the lower sheet (13) in the well is in contact with a wall of the well.

In one example, the well plate (450) includes a pin or stop that holds the lower sheet (130) of the transfer array (100) slightly above the surface of the well plate (450). The gap between the well plate (450) and the lower sheet (130) allows air flow to aid in the aspiration and expulsion of fluid from the transfer element (110). When the operations are done, the transfer array (100) may be pressed down onto the well plate (450) to seal the wells.

In one example, the stops are small pins that extend up from the well plate (450), pass through holes in the lower sheet (130) and contact a more flexible portion of the upper sheet (120). In one example, the upper sheet (120) includes crosshair cuts that align with the pins. The flaps of the crosshair cuts supporting the transfer array (100) above the well plate (450) but the flaps deflect under pressure, allowing the lower sheet (130) to seal the wells of the well plate (450). In another example, the pins are flexible and include a shoulder at a first height to support the transfer array (100) above the well plate (450). To seal the wells, the transfer array (100) is pressed down, causing the pins to deflect. After the transfer array (100) has passed the shoulder, the pins recoil and help hold the transfer array (100) in place. In one example, the deflecting pins are reversible to allow the transfer array (100) to be removed from the well plate (450). In another example, the deflecting pins are not easily deflected when the transfer array (100) is in the sealing position and the sealing is effectively a one-way process. For example, the shoulder may have a triangular shape where the slope of the triangle allows locking but a flat or steep side of the triangle makes unlocking difficult. In another example, the pins descend from the transfer array (100), either as part of the upper sheet (120) and/or lower sheet (130). The pins interact with holes or receiving features in the well plate (450).

FIG. 15 shows an example a transfer array (100) with a locking mechanism to help stabilize the upper sheet (120). The locking mechanism may be associated with the pressor plate (660). The locking mechanism includes a first support rail (1570). The locking mechanism may also have additional support rails such as a second support rail (1575).

In one example, the first support rail (1570) includes a number of retaining features that pass through the upper sheet (120) and lower sheet (130). The support rail (1570) is then moved laterally to the surface of the transfer array (100). This cause the retaining features to engage the transfer array. The retaining features may serve to stabilize the position of the transfer array (100). The retaining features may serve to hold the upper sheet (120) and/or lower sheet (130) vertically stable or in contact with each other. This is particularly useful when a pressor plate (660) engages with the transfer elements (110) to expel or aspirate fluid.

The system may also use a second support rail (1575). Like the first support rail (1570) the second support rail (1575) also passes through the upper sheet (120) and lower sheet (130) and moves laterally relative to the transfer array (100). In one example, the first and second support rails (1570, 1575) move in opposite directions to create compression/tension in the upper sheet (120) and/or lower sheet (130). This may enhance the stability of the transfer array during operation. The first support rail (1570) may also interact with the well plate (450). For example, the well plate (450) and the transfer array (100) may include coordinated openings through with the retention features of the first and/or second support rails (1570, 1575) pass. The first and/or second support rail (1570, 1575) may contact an upper portion of the upper sheet (120) and press the transfer array (100) against the well plate (450). The first and second support rails (1570, 1575) may also include a plurality of parallel rails to form a lattice or plate. In one example, the system uses a small number of retaining features, e.g. 2 to 10. In another example, the system has one retaining feature for each well. In a third example, the system has two retaining features for each well, one moving in a first direction and the other moving in a second direction.

The preceding description has been presented to illustrate and describe examples of the principles described. This description is not intended to be exhaustive or to limit these principles to any precise form disclosed. Many modifications and variations are possible in light of the above teaching.

Some additional examples consistent with this disclosure include the following:

What is claimed is:

1. A device, a transfer array for simultaneously transferring multiple aliquots of fluid, the device comprising: a formed upper sheet and a formed lower sheet contacting the upper sheet, the upper sheet and lower sheet forming a plurality of hollows between the upper formed sheet and the lower formed sheet, wherein: the plurality of hollow are spaced to align with wells in a well plate or well strip; each hollow of the plurality of hollows comprises a hole in the lower formed sheet to allow aspiration of fluid into the hollow and expulsion of fluid from the hollow; and the portion of the lower sheet forming each hollow extending away from the upper sheet.

2. The device of claim 1, wherein the portion in the upper sheet forming each hollow extends away from the lower sheet.

3. The device of claim 1, wherein the upper sheet comprises a first material and the lower sheet comprises a second, different material.

4. The device of claim 1, wherein the portion of the lower sheet forming each hollow further comprises a penetrating tip.

5. The device of claim 1, wherein the portion of the upper sheet forming each hollow further comprises an area to facilitate penetration.

6. The device of claim 1, further comprising mechanical connections between the upper sheet and lower sheet.

7. The device of claim 6, wherein the mechanical connections comprise one way features.

8. The device of claim 7, further comprising a third sheet, the third sheet comprising mechanical connections to attach to the mechanical connections of the upper sheet.

9. The device of claim 8, wherein the third sheet further comprises penetrating tips aligned with areas of reduced local thickness in the upper sheet.

10. The device of claim 1, further comprising a deposited solvent-soluble chemical component on an interior surface of a hollow.

11. The device of claim 1, wherein an upper portion of the upper sheet above a hollow comprises a mechanical attachment feature such that force applied to the mechanical attachment feature may facilitate expansion of the associated hollow.

12. The device of claim 1, wherein the upper sheet may be pressed using a flat plate so as to compress all the hollows simultaneously.

13. The device of claim 1, wherein the lower sheet is formed so as to seal wells of a multi well plate.

14. A device for providing preloaded aliquots of liquid, the device comprising: a plurality of transfer pipettes formed from two sheets of material, each transfer pipette of the plurality of transfer pipettes holding an aliquot of liquid and a tray conforming to lower tips of the transfer pipettes, the tray limiting evaporation of the liquid in the transfer pipettes.

15. The device of claim 14, wherein each transfer pipette further comprises a bulb on an upper portion of the transfer pipette, wherein compressing the bulb expels the liquid from the transfer pipette.

16. A method for transferring liquid from a first multi well plate, the method comprising: contacting the first multi well plate with a first transfer array and simultaneously aspirating fluid from multiple wells of the first multi well plate into corresponding hollows in the first transfer array.

17. The method of claim 16, further comprising: contacting a second multi well plate with the first transfer array; and simultaneously expelling fluid from multiple hollows of the first transfer array into corresponding wells of the second multi well plate.

18. The method of claim 17, wherein the aspirated fluid is a solvent which dissolves a chemical and the expelled fluid is a solution.

19. The method of claim 16, further comprising storing the first transfer array on a tray, where the first transfer array contains aspirated fluid.

20. The method of claim 16, further comprising: penetrating hollows of a second transfer array with lower tips of the first transfer array; and simultaneously expelling fluid from multiple hollows of the first transfer array into hollows of the second transfer array.

21. The method of claim 19, further comprising mechanically connecting the first transfer array to the second transfer array.

22. The method of claim 16, wherein contacting the first multi well plate with a first transfer array seals wells of the first multi well plate.
